(19) United States
(12) Patent Application Publication
(10) Pub. No.: US 2012/0096400 A1
(43) Pub. Date: Apr. 19, 2012

(54) METHOD AND APPARATUS FOR SELECTING MENU ITEM

(75) Inventor: Seong-Hun Cho, Suwon-si (KR)

(73) Assignee: SAMSUNG ELECTRONICS CO., LTD., Suwon-si (KR)

(21) Appl. No.: 13/240,799

(22) Filed: Sep. 22, 2011

(30) Foreign Application Priority Data
Oct. 15, 2010 (KR) 10-2010-0100688

(51) Int. Cl. G06F 3/048; G09G 5/08

(52) U.S. Cl. 715/810; 345/163

(57) ABSTRACT

A method for selecting an item in a terminal using a touchscreen or a mouse includes displaying items, and selecting or deselecting items that are present on a touch movement route or a mouse drag route.

CROSS-REFERENCE TO RELATED APPLICATION(S) AND CLAIM OF PRIORITY

The present application is related to and claims the benefit under 35 U.S.C. §119 to an Korean patent application filed in the Korean Intellectual Property Office on Oct. 15, 2010 and assigned Serial No. 10-2010-0100688, the entire disclosure of which is incorporated herein by reference.

### TECHNICAL FIELD OF THE INVENTION

The present invention relates generally to a method and an apparatus for selecting a menu item in a portable terminal. More particularly, the present invention relates to a method for selection several menu items easily in a portable terminal.

### BACKGROUND OF THE INVENTION

Currently, with development of electronic communication industries, portable terminals, such as mobile communication terminals (cellular phones), electronic notes, and personal digital assistants (PDA), have become indispensable in modern society. These portable terminals play an important role of transferring information that may change quickly. Under this circumstance, a mobile terminal provides additional functions.

Although these terminals have become multifunctional, overload is too much to meet a user's demand. For example, a user may select items displayed on a terminal by using an input device provided therein. Generally, a terminal using a touchscreen, a keypad or a mouse provides a method of selecting multiple items one by one, which is inefficient. Furthermore, a terminal using a mouse may select multiple items by using a cursor to designate a region covering desired items. However, such an item selecting method also is insufficient because unnecessary items may be selected within the designated region and the unnecessary items should be deselected one by one.

### SUMMARY OF THE INVENTION

To address the above-discussed deficiencies of the prior art, it is a primary object to provide at least the advantages below. Accordingly, an object of the present disclosure is to provide an item selecting method for easily selecting multiple items among items displayed on a terminal.

Another object of the present disclosure is to provide a method for selecting items that are present on a touch movement route in a terminal using a touchscreen.

Another object of the present disclosure is to provide a method for selecting items that are present on a mouse drag route in a terminal using a mouse.

According to an embodiment, a method for selecting an item in a terminal using a touchscreen or a mouse is provided. The method includes displaying items, and selecting or deselecting items that are present on a touch movement route or a mouse drag, route.

According to another embodiment, a method for selecting an item in a terminal using a touchscreen or a mouse is provided. The method includes displaying items, executing an associative selection mode according to an associative selection mode signal, and selecting items that are classified according to the execution of the associative selection mode.

According to yet another embodiment, a method for selecting an item in a terminal using a touchscreen or a mouse is provided. The method includes displaying items, marking associative items extracted among the displayed items, and selecting or deselecting items that are present on a touch movement route or a mouse drag route among the marked extracted items.

Other aspects, advantages and salient features of the disclosure will become apparent to those skilled in the art from the following detailed description, which, taken in conjunction with the annexed drawings, discloses embodiments of the disclosure.

According to an embodiment, a structure for reducing interference between an antenna and a peripheral device is provided. The structure includes an antenna module and a speaker module. The antenna module includes a carrier and the antenna attached to the carrier. The speaker module is mounted in the carrier and includes a speaker and a signal line electrically connected to the speaker. A radiation performance of the antenna module is secured by changing at least one of a shape and a length of the signal line.

According to another embodiment, a structure for reducing interference between an antenna and a peripheral device is provided. The peripheral device is connected to a signal line for receiving a signal. The antenna is influenced by the peripheral device and is configured transmit and receive radio waves. The antenna changes a radiation performance as at least one of a shape and a length of the signal line changes.

According to yet another embodiment, a method for reducing interference between an antenna and a peripheral device is provided. At least one of a shape and a length of a signal line electrically connected to a speaker is changed. A signal to the speaker is provided to secure a radiation performance of the antenna.

According to another embodiment, an apparatus for selecting an item in a terminal using one of a touch screen and a mouse is provided. The apparatus comprises an output unit for displaying items and a control unit for one of selecting and deselecting items that are present on one of a touch movement route and a mouse drag route. Preferably, one of selecting and deselecting the items that are on one of the touch movement route and the mouse drag route is accompanied by entry into a multi selection mode by generation of a multi selection mode signal.

According to another embodiment, an apparatus for selecting an item in a terminal using one of a touch screen and a mouse is provided. The apparatus comprises an output unit for displaying items and a control unit for executing an associative selection mode according to an associative selection mode signal, and selecting items that are classified according to the execution of the associative selection mode. Preferably, the associative selection mode signal is generated by one of touching and holding one of an unspecified touch region and an unspecified item for more than a predetermined time and clicking and holding one of an unspecified region of a mouse cursor area and an unspecified item for more than a predetermined time.

According to another embodiment, an apparatus for selecting an item in a terminal using one of a touch screen and a mouse is provided. The apparatus comprises an output unit for displaying items, and a control unit for marking associative items extracted among the items displayed, and one of selecting and deselecting items that are present on one of a touch movement route and a mouse drag route among the associative items extracted. Preferably, the control unit marks the associative items extracted among the items displayed by marking items having a same associative factor as an unspecified item.

Before undertaking the DETAILED DESCRIPTION OF THE INVENTION below, it may be advantageous to set forth definitions of certain words and phrases used throughout this patent document: the terms “include and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other objects, features and advantages of the present invention will become more apparent from the following detailed description when taken in conjunction with the accompanying drawings in which:

FIG. 1 is a perspective view of terminals according to embodiments of the present disclosure;

FIG. 2 is a block diagram of a terminal according to the present disclosure;

FIG. 3 is a flowchart illustrating a procedure of selecting multiple items in a multi selection mode in a terminal according to the present disclosure;

FIG. 4 is a flowchart illustrating a procedure of selecting multiple items in a multi selection mode in a terminal using a touchscreen according to the present disclosure;

FIG. 5 is a flowchart illustrating a procedure of selecting multiple items in a multi selection mode in a terminal using a mouse according to the present disclosure;

FIGS. 6A and 6B are flowcharts illustrating a procedure of selecting multiple items in an associative selection mode in a terminal using a touchscreen or a mouse according to another embodiment of the present disclosure;

FIGS. 7A and 7B are flowcharts illustrating a procedure of selecting multiple items in an associative multi selection mode in a terminal using a touchscreen or a mouse according to another embodiment of the present disclosure;

FIG. 8 illustrates one example of the multi selection mode of FIG. 3;

FIG. 9 illustrates one example of the multi selection mode of FIG. 4;

FIG. 10 illustrates one example of the associative selection mode of FIG. 6A;

FIG. 11 illustrates one example of the associative selection mode of FIG. 6B; and

FIG. 12 illustrates one example of the associative multi selection mode of FIG. 7.

Throughout the drawings, like reference numerals will be understood to refer to like parts, components and structures.

### DETAILED DESCRIPTION OF THE INVENTION

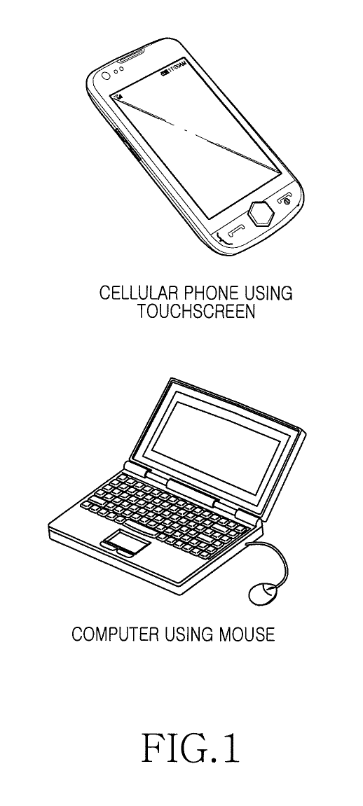

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication device. Preferred embodiments of the present invention will be described herein below with reference to the accompanying drawings. In the following description, detailed descriptions of well-known functions or configurations will be omitted since they would unnecessarily obscure the subject matters of the present invention. Also, the terms used herein are defined according to the functions of the present invention. Thus, the terms may vary depending on users' or operators' intentions or practices. Therefore, the terms used herein must be understood based on the descriptions made herein.

Hereinafter, methods for easily selecting multiple items among items displayed on a terminal will be described.

FIG. 1 is a perspective view of terminals according to embodiments of the present disclosure.

Referring to FIG. 1, the terminal includes a display device, such as a Liquid Crystal Display (LCD), which outputs data. In addition, the terminal may include an input device, such as a keypad, a touchscreen, and a mouse. As illustrated in FIG. 1, a cellular phone includes a touchscreen, and a computer includes a mouse. The cellular phone and the computer display items on their display devices. The items are created by listing a multitasking program or codes. A method of selecting a relevant item from the listed items is superior in operability to a command input method. In particular, in the case of an item selecting method using a touchscreen according to the present disclosure, items that are present on a touch movement route are selected among the displayed items. In the case of an item selecting method using a mouse according to the present disclosure, items that are present on a mouse drag are selected. For these item selecting methods, a multi selection mode should be provided. The multi selection mode is executed by the generation of a multi selection mode signal. For example, the multi selection mode may be executed when a multi selection mode signal is generated by pressing and holding any one of items on a touchscreen. In addition, the item selecting method using the touchscreen or the mouse according to the embodiment of the present disclosure may select items having the same associative factor (e.g., a file format, etc.) among the displayed items. For such an item selecting method, an associative selection mode should be provided. The associative selection mode is executed by the generation of an associative selection mode signal. In addition, the terminal according to the present disclosure may execute an associative multi selection mode of selecting items having the same associative factor and then selecting desired items among the selected items. The associative multi selection mode is executed by the generation of an associative multi selection mode signal.

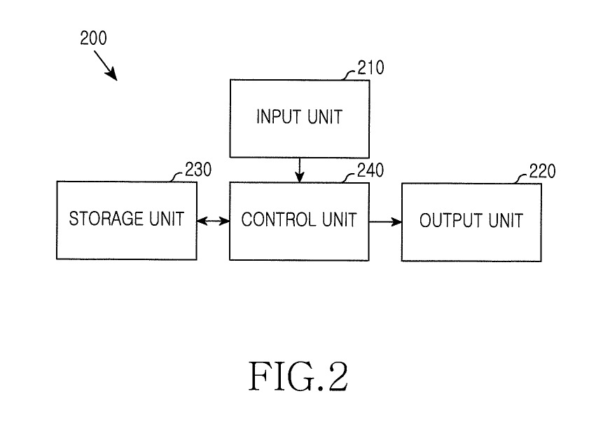

FIG. 2 is a block diagram of a terminal according to the present disclosure.

Referring to FIG. 2, the terminal 200 includes an input unit 210 for inputting data, an output unit 220 for outputting data, a storage unit 230 for storing various data, and a control unit 240 for controlling an overall operation of the terminal. The input unit 210 may use an input device, such as a touchscreen, a keypad, a mouse, and a microphone. The output unit 220 may include an image output unit for outputting an image, and an audio output unit for outputting an audio. The image output unit may use a display device, such as a Liquid Crystal Display (LCD), and the audio output unit may use a speaker, a receiver, or the like. The storage unit 230 stores various programs and data that are used for operations. The control unit 240 controls an entire system. The control unit 240 controls a series of processes of receiving data from the input unit 210, processing the received data, and transmitting the processing result to the output unit 220. Also, the control unit 240 controls the method of embodiments according to the present invention which will be described in detail.

The output unit 220 displays items under the control of the control unit 240. The control unit 240 executes a multi selection mode, an associative selection mode, or an associative multi selection mode according to a selection signal generated by the input unit 210. In these modes, the control unit 240 confirms that multiple items are selected according to the selection signal generated by the input unit 210.

In particular, as described above, the item selecting method using the touchscreen according to the embodiment of the present disclosure selects items that are present on a touch movement route among the displayed items. In addition, the item selecting method using the mouse according to the embodiment of the present disclosure selects items that are present on a mouse drag route. Additionally, if the touch movement or the mouse drag passes through unselected items, the corresponding items are selected. If the touch movement or the mouse drag passes through the selected items, the corresponding items are deselected.

Furthermore, the item selecting method using the touchscreen or the mouse according to the embodiment of the present disclosure may select items having the same associative factor (e.g., a file format, etc.) among the displayed items.

Moreover, the item selecting method using the touchscreen or the mouse according to the embodiment of the present disclosure may mark (or highlight) items having the same associative factor (e.g., a file format, etc.) among the displayed items or reselect or deselect the items that are present on the touch movement route or the mouse drag route.

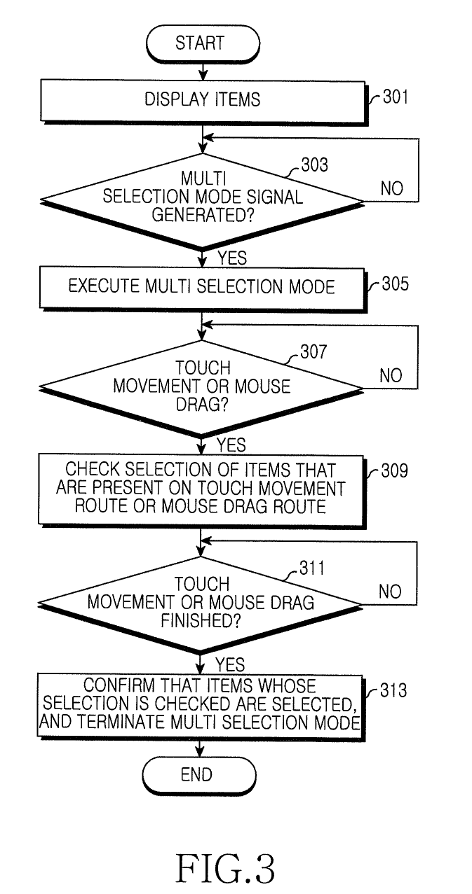

FIG. 3 is a flowchart illustrating a procedure of selecting multiple items in a multi selection mode in a terminal according to the present disclosure.

Referring to FIG. 3, the control unit 240 performs a control to display items in step 301.

In step 303, the control unit 240 determines whether a multi selection mode signal is generated.

If the control unit 240 determines in step 303 that the multi selection mode signal is generated, the control unit 240 performs a control to execute a multi selection mode in step 305.

If the multi selection mode is executed, the control unit 240 determines whether a touch movement or a mouse drag is detected in step 307.

If the touch movement or the mouse drag is detected in step 307, the control unit 240 checks the selection of items that are present on a touch movement route or a mouse drag route in step 309.

Then, the control unit 240 proceeds to step 311 to determine whether the touch movement or the mouse drag is finished.

If the touch movement or the mouse drag is finished, the control unit 240 proceeds to step 313 to confirm that the items whose selection is checked are selected, and then terminates the multi selection mode.

The multi selection mode signal may be generated by pressing and holding an unspecified item among, the displayed items, that is, by touching and holding an unspecified item for more than a predetermined time. Then, when the mode of the terminal is changed to the multi selection mode, items may be selected by a successive touch movement or a new touch movement. In addition, the multi selection mode signal may be generated by pressing and holding an unspecified item among the displayed items, that is, by pressing any one item with a mouse cursor for more than a predetermined time. Then, when the mode of the terminal is changed to the multi selection mode, items may be selected by a successive mouse drag.

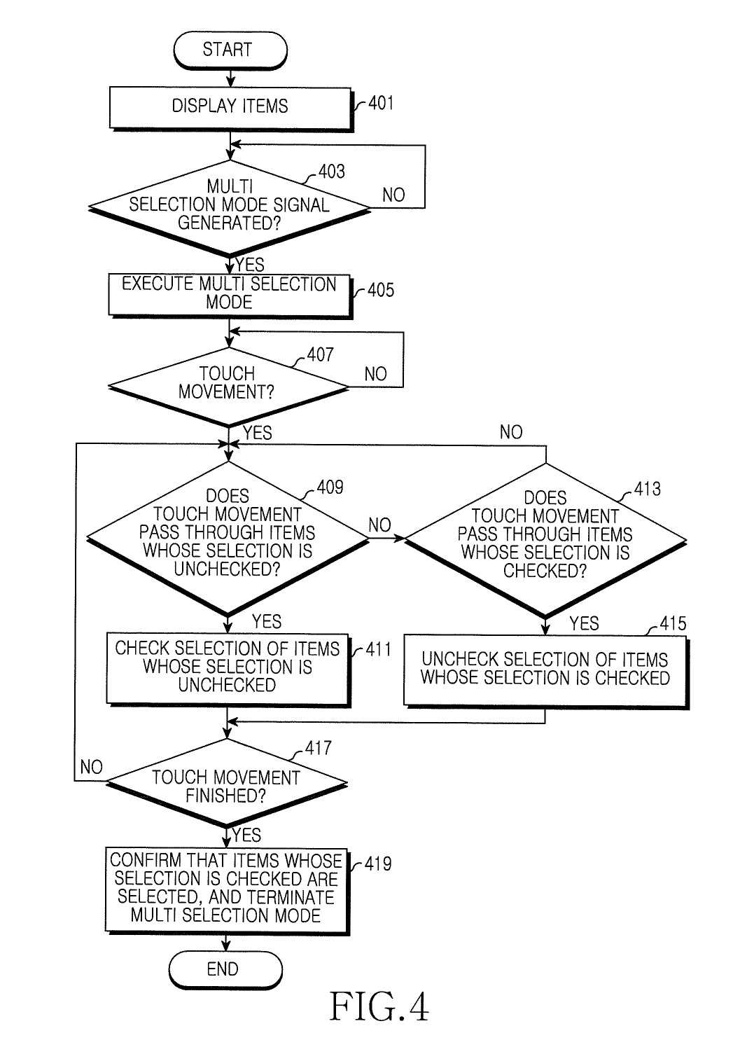

FIG. 4 is a flowchart illustrating a procedure of selecting, multiple items in a multi selection mode in a terminal using a touchscreen according to the present disclosure.

Referring to FIG. 4, the control unit 240 performs a control to display items in step 401.

In step 403, the control unit 240 determines whether a multi selection mode signal is generated.

If the control unit 240 determines in step 403 that the multi selection mode signal is generated, the control unit 240 performs a control to execute a multi selection mode in step 405.

If the multi selection mode is executed, the control unit 240 determines whether a touch movement is detected in step 407.

If the touch movement is detected in step 407, the control unit 240 proceeds to step 409 to determine whether the touch movement passes through items whose selection is unchecked. If the control unit 240 determines in step 409 that the touch movement passes through the items whose selection is unchecked, the control unit 240 checks the corresponding items as selected in step 411.

Then, the control unit 240 proceeds to step 417 to determine whether the touch movement is finished. If the touch movement is finished, the control unit 240 proceeds to step 419 to confirm that the items whose selection is checked are selected, and then terminates the multi selection mode. If the touch movement is not finished, the control unit 240 returns to step 409.

In addition, if the control unit 240 determines in step 409 that the touch movement does not pass through the items whose selection is unchecked, the control unit 240 proceeds to step 413 to determine whether the touch movement passes through the items whose selection is checked. If the touch movement does not pass through the items whose selection is checked, the control unit 240 returns to step 409. If the touch movement passes through the items whose selection is checked, the control unit 240 unchecks the corresponding items as selected in step 415. Then, the control unit 240 performs the processes following step 417.

The multi selection mode signal may be generated by pressing and holding an unspecified item among the displayed items, that is, by touching and holding an unspecified item for more than a predetermined time. Then, when the mode of the terminal is changed to the multi selection mode, items may be selected or deselected by a successive touch movement or a new touch movement. In addition, the multi selection mode signal may be generated by touching an unspecified item twice.

In addition, the multi selection mode signal may be generated by pressing and holding a touch area except the displayed items or touching the touch area twice.

Furthermore, the displayed items may include a specific item for generating the multi selection mode signal, and the multi selection mode may be immediately executed by touching the specific item.

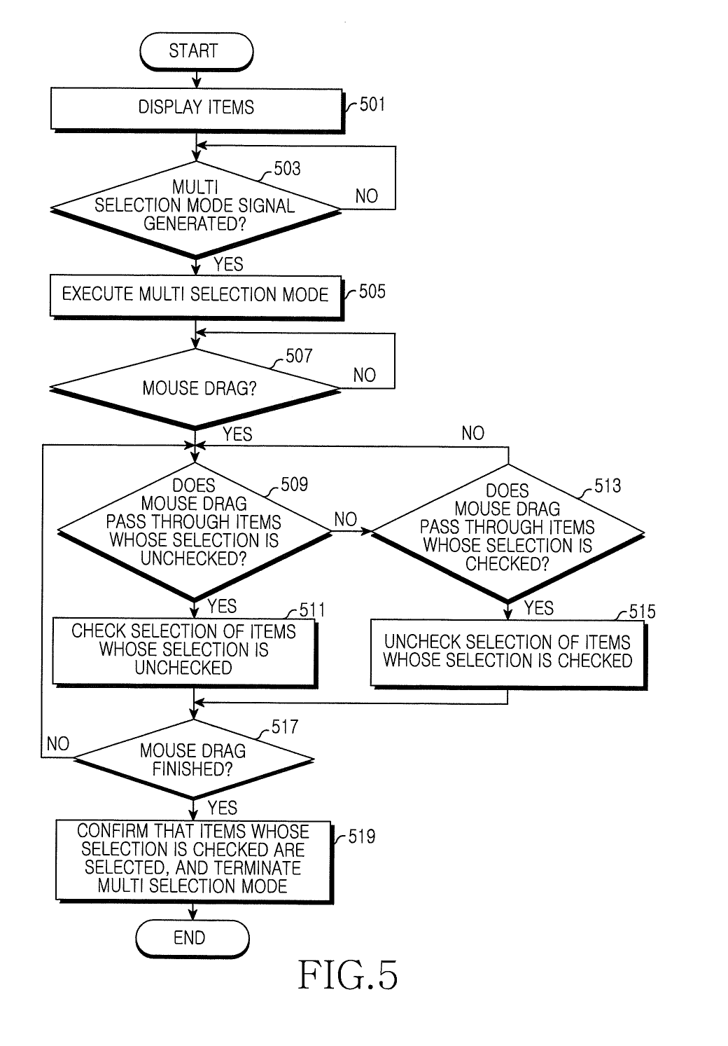

FIG. 5 is a flowchart illustrating a procedure of selecting multiple items in a multi selection mode in a terminal using a mouse according to the present disclosure.

Referring to FIG. 5, the control unit 240 performs a control to display items in step 501.

In step 503, the control unit 240 determines whether a multi selection mode signal is generated.

If the control unit 240 determines in step 503 that the multi selection mode signal is generated, the control unit 240 performs a control to execute a multi selection mode in step 505.

If the multi selection mode is executed, the control unit 240 determines whether a mouse drag is detected in step 507.

If the mouse drag is detected in step 507, the control unit 240 determines whether the mouse drag passes through items whose selection is unchecked in step 509. If the control unit 240 determines in step 509 that the mouse drag passes through the items whose selection is unchecked, the control unit 240 checks the corresponding items as selected in step 511.

Then, the control unit 240 proceeds to step 517 to determine whether the mouse drag is finished. If the mouse drag is finished, the control unit 240 proceeds to step 519 to confirm that the items whose selection is checked are selected, and then terminates the multi selection mode. If the mouse drag is not finished, the control unit 240 returns to step 509.

In addition, if the control unit 240 determines in step 509 that the touch movement does not pass through the items whose selection is unchecked, the control unit 240 proceeds to step 513 to determine whether the mouse drag passes through the items whose selection is checked. If the mouse drag does not pass through the items whose selection is checked, the control unit 240 returns to step 509. If the mouse drag passes through the items whose selection is checked, the control unit 240 unchecks the corresponding items in step 515. Then, the control unit 240 performs the processes following step 517.

The multi selection mode signal may be generated by pressing and holding an unspecified item among the displayed items, that is, by pressing and holding an unspecified item with a mouse cursor for more than a predetermined time. Then, when the mode of the terminal is changed to the multi selection mode, items may be selected or deselected by a successive mouse drag or a new mouse drag.

Furthermore, in the embodiments illustrated in FIGS. 3 to 5, if the touch movement and the mouse drag arrive at the end of the screen when the multi selection mode is in an active state, the screen may be scrolled to display new items, and the items may be selected by a successive touch movement and a mouse drag on the scrolled screen. However, if there are no items to be displayed on the scrolled screen, the screen is not scrolled.

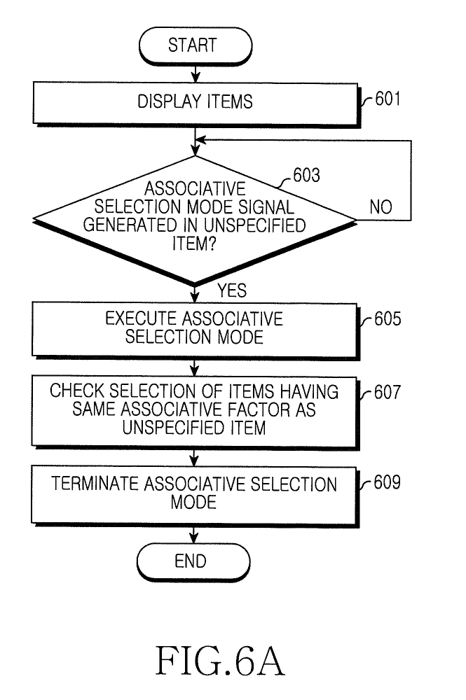

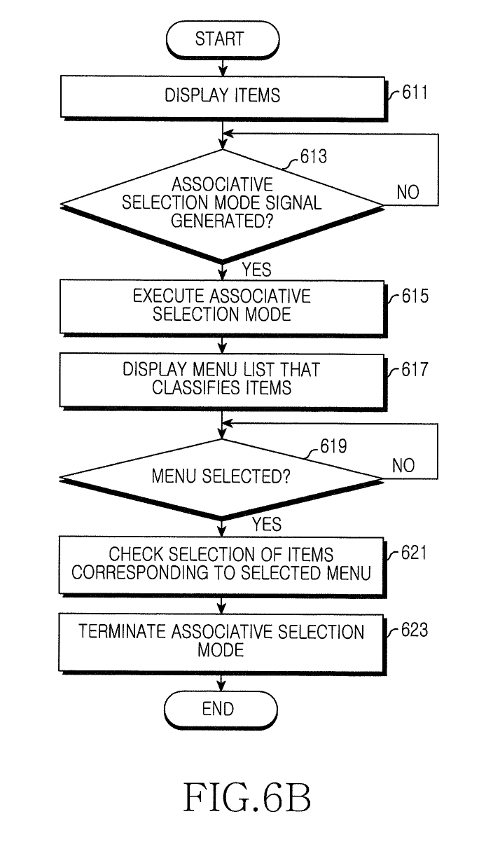

FIGS. 6A and 6B are flowcharts illustrating a procedure of selecting multiple items in an associative selection mode in a terminal using a touchscreen or a mouse according to another embodiment of the present disclosure.

Referring to FIG. 6A, the control unit 240 performs a control to display items in step 601.

In step 603, the control unit 240 determines whether an associative selection mode signal is generated in an unspecified item.

If the associative selection mode signal is generated in the unspecified item, the control unit 240 performs a control to execute an associative selection mode in step 605.

If the associative selection mode is executed, the control unit 240 checks the selection of items having the same associative factor as the unspecified item in step 607. For example, the items whose selection is checked may have the same file format (e.g., a photo file, a video file, a text file, etc.).

Then, the control unit 240 terminates the associative selection mode in step 609.

Referring to FIG. 6B, the control unit 240 performs a control to display items in step 611.

In step 613, the control unit 240 determines whether an associative selection mode signal is generated.

If the associative selection mode signal is generated, the control unit 240 performs a control to execute an associative selection mode in step 615.

If the associative selection mode is executed, the control unit 240 displays a menu list that classifies the items in step 617. The menu list includes a menu that may classify the items displayed in step 611. For example, the menu may be a photo, a video, and a text.

The control unit 240 confirms that the menu is selected in the menu list in step 619, and proceeds to step 621 to check the selection of items corresponding to the selected menu.

In step 623, the control unit 240 terminates the associative selection mode.

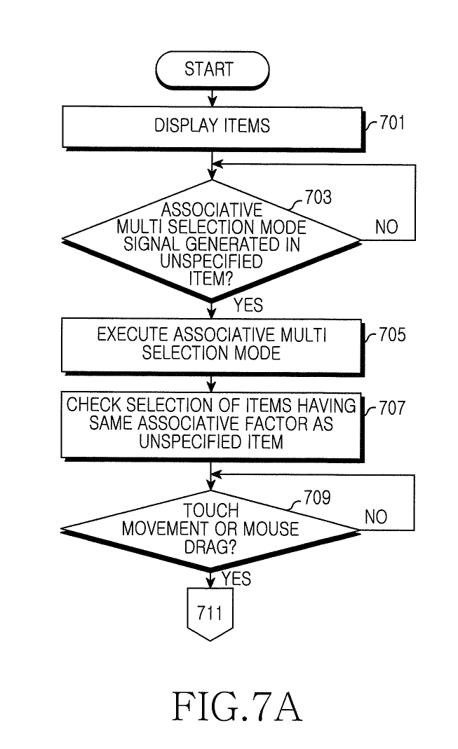

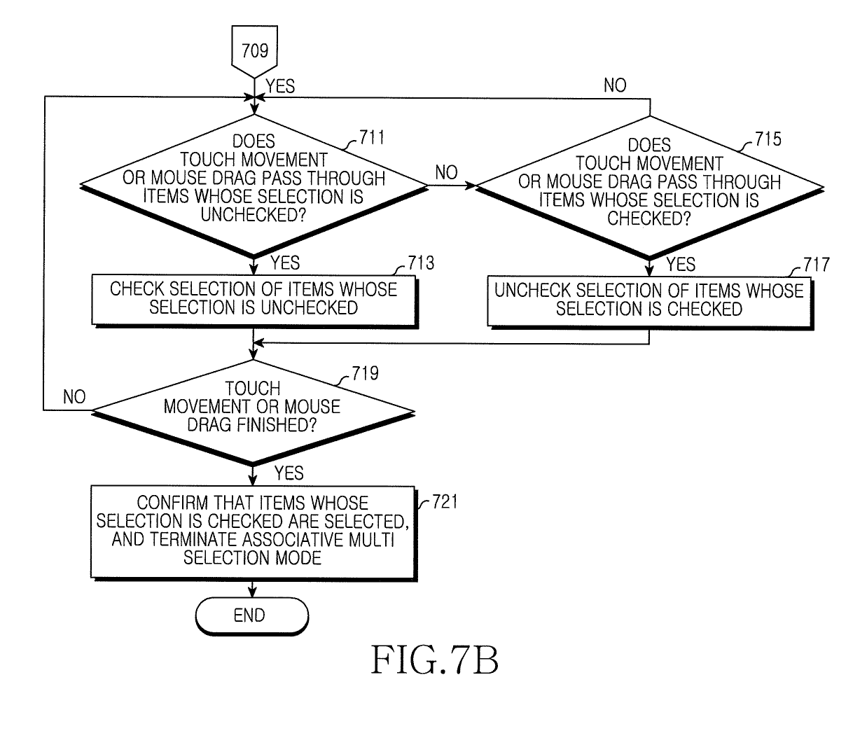

FIGS. 7A and 7B are flowcharts illustrating a procedure of selecting multiple items in an associative multi selection mode in a terminal using a touchscreen or a mouse according to another embodiment of the present disclosure.

Referring to FIGS. 7A and 7B, the control unit 240 performs a control to display items in step 701.

In step 703, the control unit 240 determines whether an associative multi selection mode signal is generated in an unspecified item.

If the associative multi selection mode signal is generated in the unspecified item, the control unit 240 performs a control to execute an associative multi selection mode in step 705.

If the associative multi selection mode is executed, the control unit 240 checks the selection of items having the same associative factor as the unspecified item in step 707. For example, the items whose selection is checked may have the same file format (e.g., a photo file, a video file, a text file, etc.).

Then, the control unit 240 proceeds to step 709 to determine whether a touch movement or a mouse drag is detected. The touch movement or the mouse drag may be a touch movement successive to the touch of the unspecified item or a drag successive to a mouse click.

If the touch movement or the mouse drag is detected in step 709, the control unit 240 determines whether the touch movement or the mouse drag passes through the items whose selection is unchecked. If the touch movement or the mouse drag passes through the items whose selection is unchecked, the control unit 240 checks the selection of the corresponding items again in step 713.

Then, the control unit 240 proceeds to step 719 to determine whether the touch movement or the mouse drag is finished. If the touch movement or the mouse drag is finished, the control unit 240 proceeds to step 721 to confirm that the items whose selection is checked are selected, and then terminates the associative multi selection mode. If the touch movement or the mouse drag is not finished, the control unit 240 returns to step 711.

If the touch movement or the mouse drag does not pass through the items whose selection is unchecked in step 711, the control unit 240 proceeds to step 715 to determine whether the touch movement or the mouse drag passes through the items whose selection is checked. If the touch movement or the mouse drag does not pass through the items whose selection is checked, the control unit 240 returns to step 711. If the touch movement or the mouse drag passes through the items whose selection is checked, the control unit 240 unchecks the selection of the corresponding items in step 717. Then, the control unit 240 performs the processes following step 719.

The associative multi selection mode signal may be generated by pressing and holding an unspecified item, that is, by touching and holding an unspecified item for more than a predetermined time. Then, when the mode of the terminal is changed to the associative multi selection mode, items may be selected by a successive touch movement or a new touch movement. In addition, the associative multi selection mode signal may be generated by pressing and holding an unspecified item among the displayed items, that is, by pressing and holding an unspecified item with a mouse cursor for more than a predetermined time. Then, when the mode of the terminal is changed to the associative multi selection mode, items may be selected by a successive mouse drag.

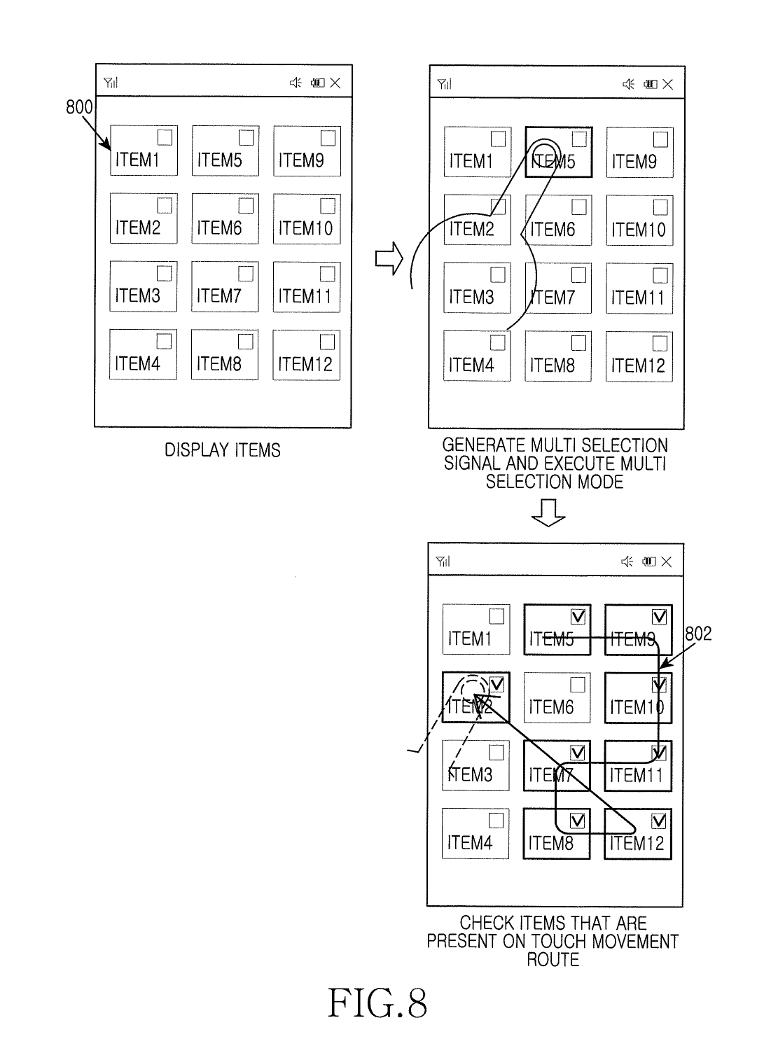

FIG. 8 illustrates one example of the multi selection mode of FIG. 3.

Referring to FIG. 8, items 800 are displayed. If a multi selection mode signal is generated in an unspecified item (in this example, an item 5) among the displayed items, a multi selection mode is executed. The multi selection mode signal may be generated by touching and holding an unspecified item for more than a predetermined time. In the multi selection mode, if a touch movement successive to the touch occurs, items that are present on the touch movement route 802 are checked as selected.

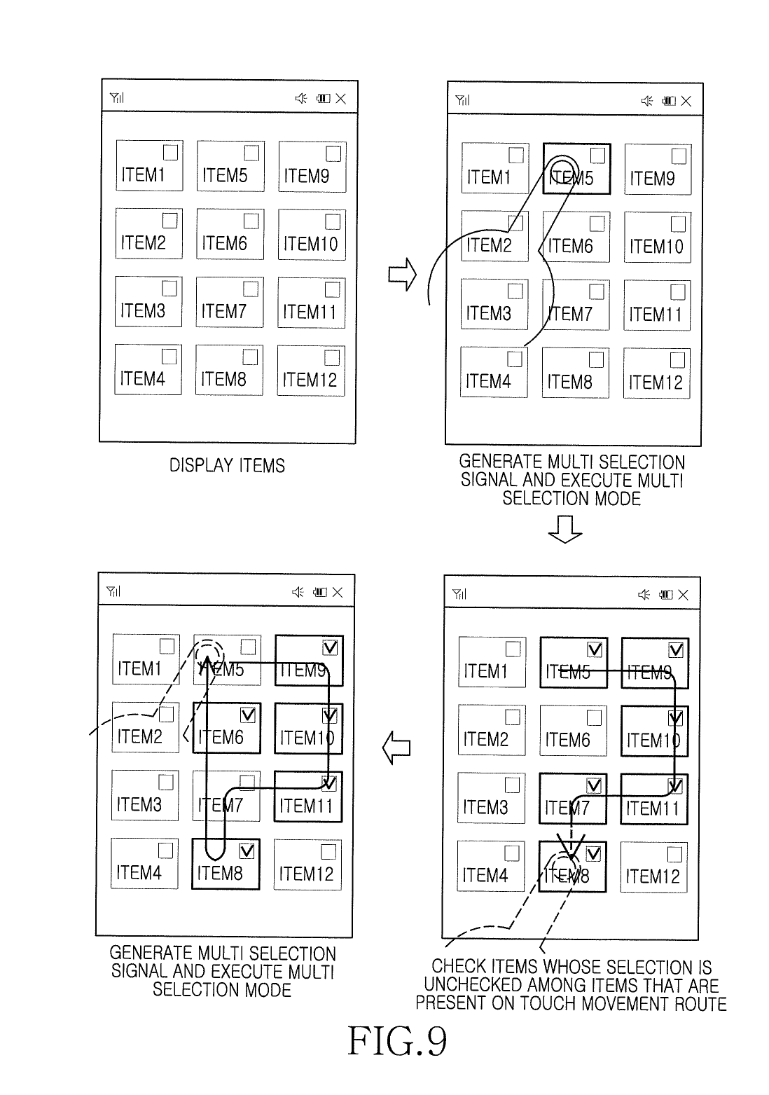

FIG. 9 illustrates one example of the multi selection mode of FIG. 4.

Referring to FIG. 9, items are displayed. If a multi selection mode signal is generated in an unspecified item (in this example, an item 5) among the displayed items, a multi selection mode is executed. The multi selection mode signal may be generated by touching and holding an unspecified item for more than a predetermined time. In the multi selection mode, if a touch movement successive to the touch occurs, items 5, 9, 10, 11, 7 and 8 whose selection is unchecked among the items that are present on the touch movement route are checked as selected. In addition, items 7 and 5 whose selection is checked among the items that are present on the touch movement route are checked as deselected.

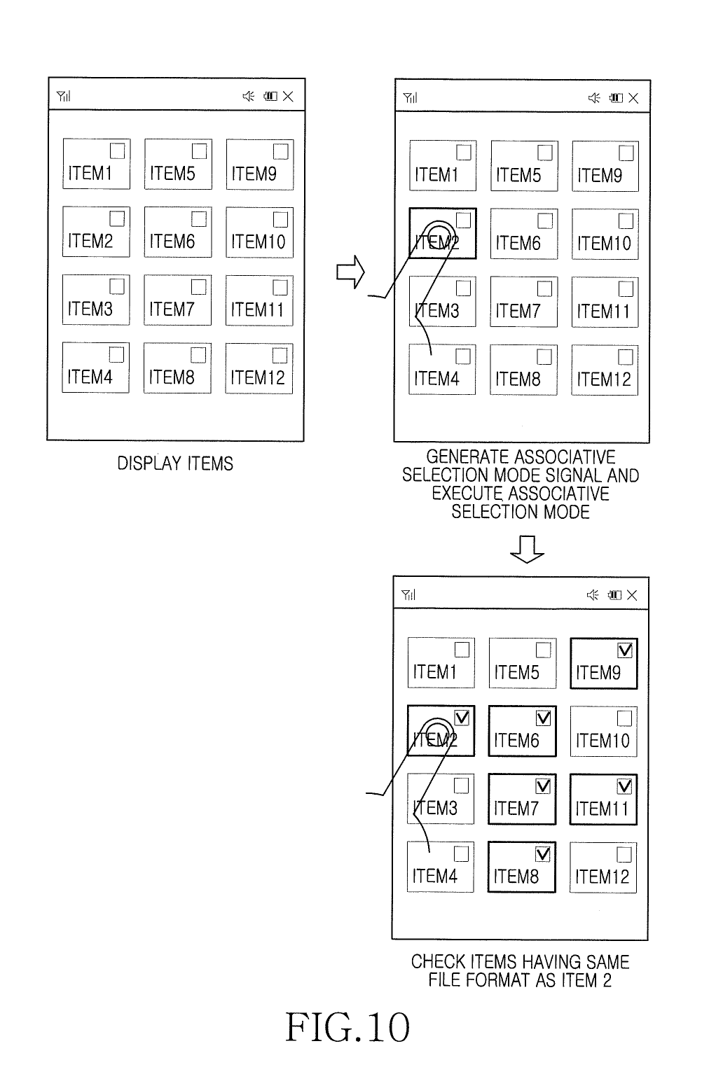

FIG. 10 illustrates one example of the associative selection mode of FIG. 6A.

Referring to FIG. 10, items are displayed. If an associative selection mode signal is generated in an unspecified item (in this example, an item 2) among the displayed items, an associative selection mode is executed. The associative selection mode signal may be generated by touching and holding an unspecified item for more than a predetermined time. If the associative multi selection mode is executed, items 2, 6, 7, 8, 9 and 11 having the same file format as the item 2 are checked as selected.

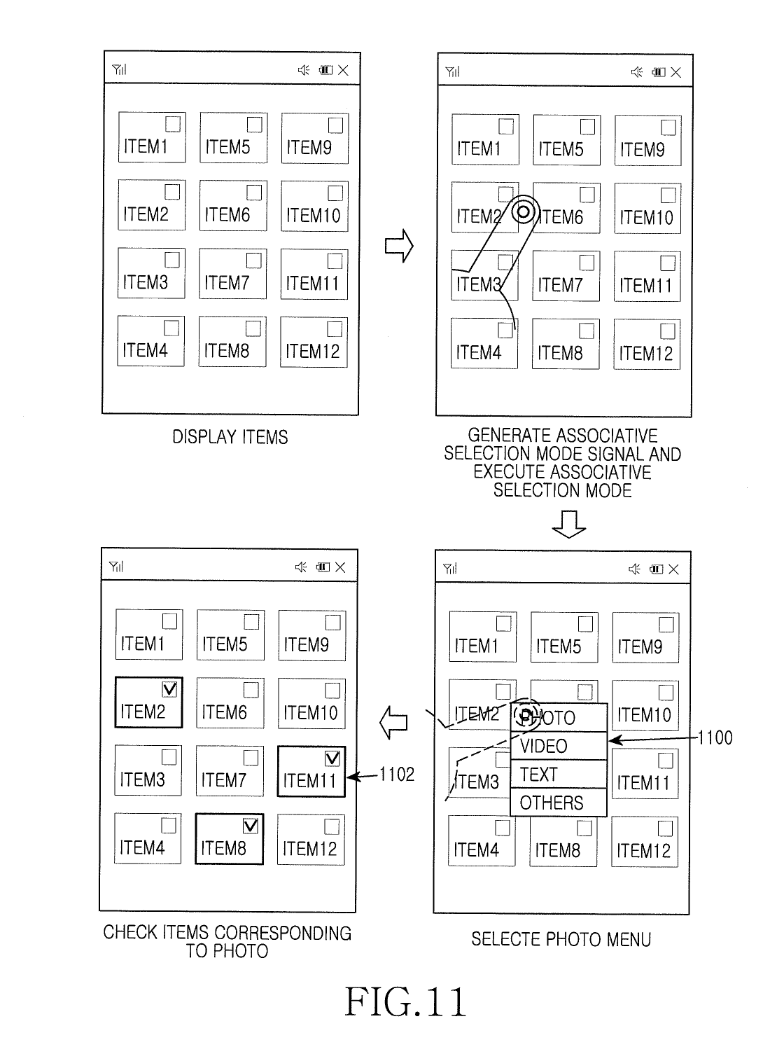

FIG. 11 illustrates one example the associative selection mode of FIG. 6B.

Referring to FIG. 11, items are displayed. If an associative selection mode signal is generated, an associative selection mode is executed. The associative selection mode signal may be generated by touching and holding an unspecified region for more than a predetermined time. The associative multi selection mode displays a menu list 1100 that classifies the items. The menu list 1100 includes a menu that can classify the items. As illustrated in FIG. 11, the menu may be a photo, a video, a text, and others. If any one menu (in this example, photo) is selected in the menu, items 2, 8 and 11 1102 corresponding to the photo are checked as selected.

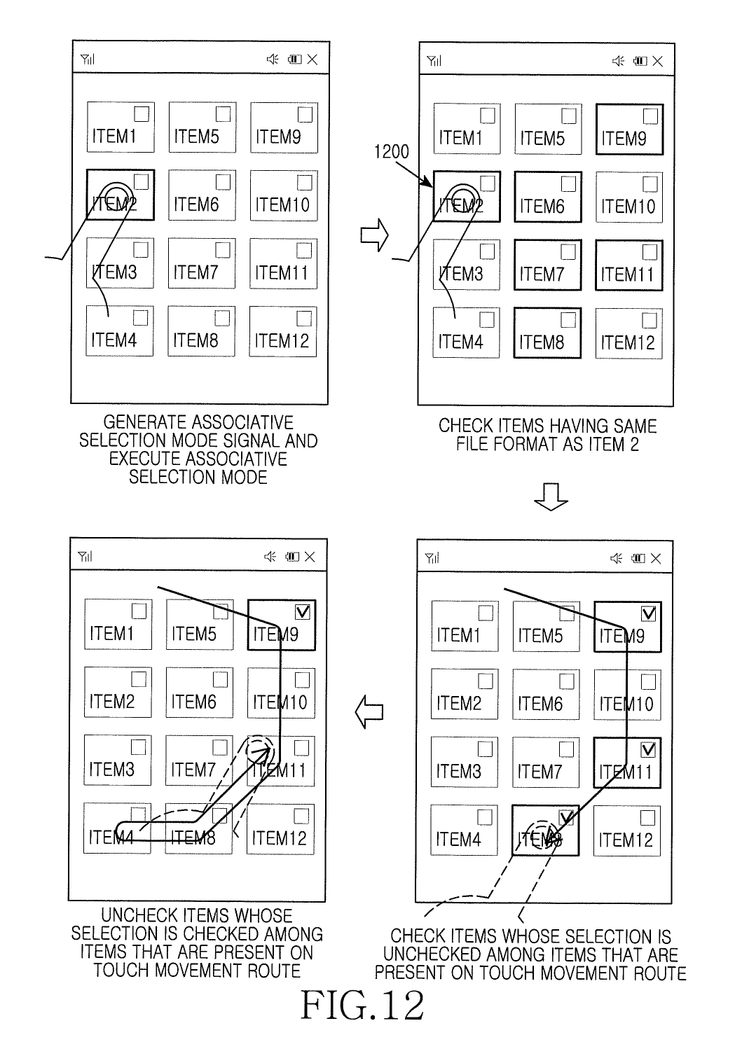

FIG. 12 illustrates one example the associative multi selection mode of FIG. 7.

Referring to FIG. 12, if an associative multi selection signal is generated in an unspecified item 1200 (in this example, an item 2) among displayed items, an associative multi selection mode is executed. If the associative multi selection mode is executed, items 2, 6, 7, 8, 9 and 11 having the same file format as the item 2 are checked as selected. Then, items among the items having the same file format as the item 2 may be selected or deselected. If a touch movement occurs, items 8, 9 and 11 whose selection is unchecked among the items that are present on the touch movement route are checked as selected. In addition, items 8 and 11 whose selection is checked among the items that are present on the touch movement route is unchecked.

Consequently, the item selecting methods according to the embodiments of the present disclosure can easily select multiple items.

Although the invention has been shown and described with reference to certain embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A method for selecting an item in a terminal using one of a touchscreen and a mouse, the method comprising:
displaying items; and
one of selecting and deselecting items that are present on one of a touch movement route and a mouse drag route.

2. The method of claim 1, wherein one of selecting and deselecting the items that are on one of the touch movement route and the mouse drag route is accompanied by entry into a multi selection mode by generation of a multi selection mode signal.

3. The method of claim 2, wherein the multi selection mode signal is generated by one of touching and holding one of an unspecified touch region and an unspecified item for more than a predetermined time and clicking and holding an unspecified region of one of a mouse cursor area and an unspecified item for more than a predetermined time.

4. The method of claim 2, wherein the multi selection mode signal is generated by one of touching and holding one of an unspecified touch region and an unspecified item twice and clicking and holding an unspecified region of one of a mouse cursor area and an unspecified item twice.

5. The method of claim 2, wherein, one of selecting and deselecting the items that are present on one of the touch movement route and the mouse drag route comprises:
responsive to one of the touch movement and the mouse drag passing through deselected items, selecting the deselected items, and
responsive to one of the touch movement and the mouse drag passing through selected items, deselecting the selected items.

6. The method of claim 2 further comprising:
responsive to entry into in the multi selection mode and responsive to one of the touch movement and the mouse drag reaching an end of a screen, scrolling a screen displaying a new item and one of selecting and deselecting items that are present on one of a successive touch movement and a mouse drag on the screen.

7. A method for selecting an item in a terminal using one of a touchscreen and a mouse, the method comprising:
displaying items;
executing an associative selection mode according to an associative selection mode signal; and
selecting items that are classified according to the execution of the associative selection mode.

8. The method of claim 7, wherein the associative selection mode signal is generated by one of touching and holding one of an unspecified touch region and an unspecified item for more than a predetermined time and clicking and holding one of an unspecified region of a mouse cursor area and an unspecified item for more than a predetermined time.

9. The method of claim 8, wherein selecting the items that are classified according to the execution of the associative selection mode comprises:
selecting items having a same associative factor as the unspecified item.

10. The method of claim 7, wherein selecting the items that are classified according to the execution of the associative selection mode comprises:
displaying a menu list that classifies the items; and
responsive to a menu being selected in the menu list, selecting items corresponding to the menu selected.

11. The method of claim 9, wherein the associative factor is a file format.

12. The method of claim 10, wherein the menu list includes a photo, a video, and a text.

13. A method for selecting an item in a terminal using one of a touchscreen and a mouse, the method comprising:
displaying items;
marking associative items extracted among the items displayed; and
one of selecting and deselecting items that are present on one of a touch movement route and a mouse drag route among the associative items extracted.

14. The method of claim 13, wherein marking the associative items extracted among the items displayed comprises:
marking, items having a same associative factor as an unspecified item.

15. The method of claim 13, wherein marking the associative items extracted among the items displayed comprises:
displaying a menu list that classifies the items; and
responsive to a menu being selected in the menu list, marking items corresponding to the menu selected.

16. The method of claim 14, wherein the associative factor is a file format.

17. The method of claim 15, wherein the menu list includes a photo, a video, and a text.

18. The method of claim 13, wherein one of selecting and deselecting the items that are present on one of the touch movement route and the mouse drag route among the associative items marked comprises:
responsive to one of the touch movement and the mouse drag passing through deselected items, selecting the deselected items, and
responsive to one of the touch movement and the mouse drag passing through selected items, deselecting the selected items.

19. The method of claim 13, wherein marking the associative items extracted among the items displayed is accompanied by execution of an associative multi selection mode according to an associative multi selection mode signal.

20. The method of claim 19, wherein the associative multi selection mode signal is generated by one of touching and holding one of an unspecified touch region and an unspecified item for more than a predetermined time and one of clicking and holding one of an unspecified region of a mouse cursor area and an unspecified item for more than a predetermined time.

21. An apparatus for selecting an item in a terminal using one of a touch screen and a mouse, the apparatus comprising:
an output unit configured to display items; and
a control unit configured to one of select and deselect items that are present on one of a touch movement route and a mouse drag route.

22. The apparatus of claim 21, wherein one of selecting and deselecting the items that are on one of the touch movement route and the mouse drag route is accompanied by entry into a multi selection mode by generation of a multi selection mode signal.

23. An apparatus for selecting an item in a terminal using one of a touch screen and a mouse, the apparatus comprising:
an output unit configured to display items; and
a control unit configured to execute an associative selection mode according to an associative selection mode signal and select items that are classified according to the execution of the associative selection mode.

24. The apparatus of claim 23, wherein the associative selection mode signal is generated by one of touching and holding one of an unspecified touch region and an unspecified item for more than a predetermined time and clicking and holding one of an unspecified region of a mouse cursor area and an unspecified item for more than a predetermined time.

25. An apparatus for selecting an item in a terminal using one of a touch screen and a mouse, the apparatus comprising:
an output unit configured to display items; and
a control unit configured to mark associative items extracted among the items displayed, and one of selecting and deselecting items that are present on one of a touch movement route and a mouse drag route among the associative items extracted.

26. The apparatus of claim 25, wherein the control unit marks the associative items extracted among the items displayed by marking items having a same associative factor as an unspecified item.
